(19) United States
(12) Patent Application Publication
(10) Pub. No.: US 2025/0218299 A1
(43) Pub. Date: Jul. 3, 2025

(54) AUTONOMOUS VEHICLE PULLOVER CLUSTERING PREVENTION

(71) Applicant: GM CRUISE HOLDINGS LLC, SAN FRANCISCO, CA (US)

(72) Inventors: Or Cohen, San Francisco, CA (US); Steven Kobori, San Francisco, CA (US); Brendan Tomoschuk, San Diego, CA (US)

(73) Assignee: GM CRUISE HOLDINGS LLC, SAN FRANCISCO, CA (US)

(21) Appl. No.: 18/403,274

(22) Filed: Jan. 3, 2024

(51) Int. Cl. G08G 1/00; B60W 40/00; B60W 60/00; G06Q 50/47

(52) U.S. Cl. CPC G08G 1/202; B60W 40/00; B60W 60/00253; G06Q 50/47

(57) ABSTRACT

Disclosed are embodiments for facilitating autonomous vehicle (AV) pullover clustering prevention. In some aspects, an embodiment includes receiving identification of an origin location and a destination location corresponding to a transportation trip request for an AV; determining a set of pullover locations comprising pickup locations for the origin location and drop-off locations for the destination location; for each pullover location of the set of pullover locations: determining an estimated time of arrival (ETA) time window for the AV at the pullover location; determining a number of other AVs expected to be at the pullover location during the ETA time window; and responsive to the number of other AVs expected to be at the pullover location during the ETA time window exceeding an AV pullover crowding metric, removing the pullover location from the set of pullover locations to produce a revised set of pullover locations.

### BACKGROUND

### 1. Technical Field

The disclosure generally relates to the field of processing systems and, more specifically, to autonomous vehicle (AV) pullover clustering prevention.

### 2. Introduction

Autonomous vehicles, also known as self-driving cars, driverless vehicles, and robotic vehicles, may be vehicles that use multiple sensors to sense the environment and move without a human driver. An example autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

### BRIEF DESCRIPTION OF THE DRAWINGS

The various advantages and features of the disclosed technology will become apparent by reference to specific embodiments illustrated in the appended drawings. A person of ordinary skill in the art will understand that these drawings show some examples of the disclosed technology and would not limit the scope of the disclosed technology to these examples. Furthermore, the skilled artisan will appreciate the principles of the disclosed technology as described and explained with additional specificity and detail through the use of the accompanying drawings in which:

FIG. 1 is a block diagram of a detailed view of an example ride sharing platform providing for AV pullover clustering prevention, in accordance with embodiments herein;

FIG. 2 illustrates an example method implementing AV pullover clustering prevention, in accordance with embodiments herein;

FIG. 3 illustrates an example method for defining an AV pullover crowding metric for AV pullover clustering prevention, in accordance with embodiments herein;

FIG. 4A illustrates an example method for implementing an AV pullover clustering mitigation process, in accordance with embodiments herein

FIG. 4B illustrates an example method for implementing an AV pullover clustering mitigation process using a probabilistic approach, in accordance with embodiments herein;

FIG. 5 illustrates an example system environment that can be used to facilitate AV dispatch and operations, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the disclosure is the gathering and use of data available from various sources to improve quality and experience. The disclosure contemplates that in some instances, this gathered data may include personal information. The disclosure contemplates that the entities involved with such personal information respect and value privacy policies and practices.

Autonomous vehicles (AVs), also known as self-driving cars, driverless vehicles, and robotic vehicles, can be implemented by companies to provide self-driving car services for the public, such as taxi or ride-hailing (e.g., ridesharing) services. The AV can navigate about roadways without a human driver based upon sensor signals output by sensor systems deployed on the AV. AVs may utilize multiple sensors to sense the environment and move without a human driver. An example AV can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

AVs may be utilized to provide taxi or ride-hailing (e.g., ridesharing) services, which service transportation trips for users. As part of a transportation trip request flow of a ridesharing service, a user may enter requested pickup and drop-off locations (pullover locations) for the user's transportation trip. System-level components of the ridesharing service may then provide a preview of the requested trip to the user. In some cases, the user can optionally refine the exact pullover locations. If the user chooses to refine the pullover locations, a set of pullover options may be presented to the user. In both the initial preview and the optional pullover refinement, the system-level components of the ridesharing service may determine a route for the AV to travel between the pullover locations. Although described in relation to ridesharing, a similar system and set of options may be present for product delivery. For example, a product delivery system may select a pickup location for a product provided by a merchant and the merchant may refine the exact pickup location that the AV will use. Similarly, the product delivery system may select a drop-off location for the product provided by to a consumer and the consumer may refine the exact drop-off location that the AV will use.

A problem encountered in servicing transportation trips for users occurs when multiple AVs are requested at the same location within a short period of time. This causes the AVs to cluster and interfere with one another at the location. This is referred to herein as AV crowding or AV clustering. AV crowding/clustering at a pullover location can cause slowdowns for users, increased reliance on remote assistance, and increased risk of vehicle retrieval events, wherein the AVs become stuck and need assistance from a human operator. Clustering of vehicles is particularly problematic for AVs as AVs may be more cautious and unable or unwilling to navigate in tight spaces where the probability of impacting with other vehicles increases.

In order to address the above-noted technical problems associated with AV crowding, embodiments herein provide AV pullover clustering prevention. The AV pullover clustering prevention can be implemented by a routing component of a ridesharing platform. In some embodiments, an internal definition of an AV crowd (AV cluster) is identified and measured. The internal definition of the AV crowd may include a number of AVs, a distance between AVs, and a time frame the AVs are within the distance. The AV pullover clustering prevention can, when an AV is requested to a certain location, adjust the AV's intended destination to diffuse any AV crowding (As defined by the internal definition of the AV crowd) at the location. In one embodiment, if a pullover option is determined to exceed a determined crowding score threshold, that pullover option is not provided as an option to the user. For example, in the initial preview approach described above, the “next best” pullover option is presented to the user instead.

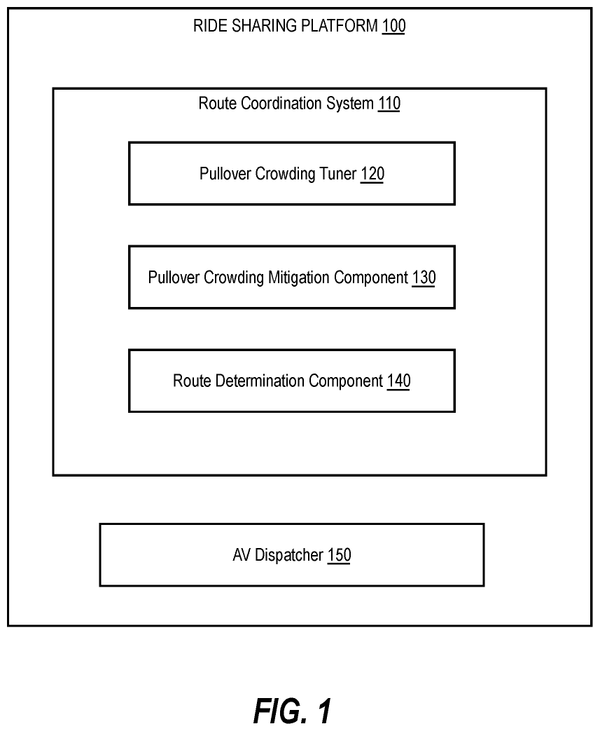

Although some embodiments herein are described as operating in an AV, other embodiments may be implemented in an environment that is not an AV, such as, for example, other types of vehicles (human operated, driver-assisted vehicles, etc.), air and terrestrial traffic control, radar astronomy, air-defense systems, anti-missile systems, marine radars to locate landmarks and other ships, aircraft anti-collision systems, ocean surveillance systems, outer space surveillance and rendezvous systems, meteorological precipitation monitoring, altimetry and flight control systems, guided missile target locating systems, ground-penetrating radar for geological observations, and so on. Furthermore, other embodiments may be more generally implemented in any artificial intelligence and/or machine learning-type environment. The following description discussed embodiments as implemented in an automotive environment, but one skilled in the art will appreciate that embodiments may be implemented in a variety of different environments and use cases. Further details of the AV pullover clustering prevention of embodiments herein are further described below with respect to FIGS. 1-6.

FIG. 1 is a block diagram of a detailed view of an example ride sharing platform 100 providing for AV pullover clustering prevention, in accordance with embodiments herein. In one embodiment, ride sharing platform 100 can be, for example, part of a data center that is cloud-based or otherwise. In other examples, the ride sharing platform 100 can be part of an AV or a human-operated vehicle having an advanced driver assistance system (ADAS) that can utilize various sensors including radar sensors.

In one embodiment, the ride sharing platform 100 is part of a system that can communicate over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.). In one embodiment, ride sharing platform 100 can be implemented using a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth.

The system hosting ride sharing platform 100 may be part of a data center for managing a fleet of AVs and AV-related services. The data center can send and receive various signals to and from an AV. These signals can include sensor data captured by the sensor systems of the AV, roadside assistance requests, software updates, ridesharing pick-up and drop-off instructions, and so forth. In some examples, the ride sharing platform 100 may be hosted in a data center that may also support a ridesharing service, a delivery service, a remote/roadside assistance service, street services (e.g., street mapping, street patrol, street cleaning, street metering, parking reservation, etc.), and the like. In some embodiments, the ride sharing platform 100 may be implemented in the AV itself or may be implemented in a server computing device.

In some embodiments, the ride sharing platform 100 is utilized to provide AV pullover clustering prevention for transportation trips. In embodiments herein, the ride sharing platform 100 can include a route coordination system 110 and an AV dispatcher 150 to enable the AV pullover clustering prevention for transportation trips discussed herein. In some embodiments, the route coordination system 110 may implement various techniques and methodologies to optimize transportation trip routes to prevent AV pullover clustering/crowding.

In embodiments herein, the ride sharing platform 100 can perform AV pullover clustering prevention for transportation trips for self-driving car services, such as taxi or ride-hailing (e.g., ridesharing) services. The route coordination system 110 may include a pullover crowding tuner 120, a pullover crowding mitigation component 130, and a route determination component 140. The pullover crowding tuner 120 and the pullover crowding mitigation component 130 operate to enable determination of a route, including pullover locations, by route determination component 140 that mitigates pullover location clustering of A Vs to prevent crowds of AVs, thus improving traffic and utilization of AVs by the self-driving car service.

Embodiments herein provide a two-fold approach to AV pullover clustering prevention. First, an internal definition of an AV crowd (or AV cluster) is identified and measured by pullover crowding tuner 120. Second, when an AV is hailed (or navigating to) an indicated location, an AV pullover crowing mitigation process is performed to adjust the AV's intended pullover location to diffuse any potential AV clustering at the pullover location.

With respect to the first portion of the AV pullover clustering prevention approach, the pullover crowding tuner 120 of route coordination system 110 can determine an internal definition of an AV crowd. In some embodiments, an internal definition of an AV crowd (AV cluster) is identified and measured. The internal definition of the AV crowd may include a number of AVs, a distance between AVs, and a time frame the AVs are within the distance. Embodiments herein may systematically vary the above features of the AV crowd over a source of truth. In one embodiment, the source of truth may be a number of remote assistance (RA) sessions that occur. However, other metrics can be utilized as a source of truth to determine an AV crowd definition and are not limited to RA sessions as a source of truth.

In one example embodiment, the pullover crowding tuner may implement a two-stage clustering algorithm that varies values for the number of AVs, the distance between AVs, and the time frame (before and after AV arrival timestamp) in order to determine the set of values that are associated with a substantial increase in RA sessions. The determined values associated with a substantial increase in RA sessions can be utilized for the internal definition of the AV crowd.

In some embodiments, the pullover crowding tuner 120 may not identify a clear cut set of variables and may have to estimate variable values that are closest to satisfying the crowding event source of truth. For example, one possible definition of an AV crowd, based on the results of the clustering algorithm, may be 5 AVs, within 30 meters, and within a 2 minute time frame. However, this definition of an AV crowd may vary as the operational functionality of the AVs changes as well as any other factors affecting the AV and/or AV pullover locations become relevant.

In some embodiments, the pullover crowding tuner 120 may implement other approaches to measuring and identifying an AV crowd. For example, the source of truth can be any connected RA sessions. However, the RA sessions considered may be filtered by sessions of a certain amount of time, with a certain label from the RA, or sessions that had direct intervention, for example. In some embodiments, the RA sessions considered may also be filtered by sessions having a determined severity level (e.g., including blocking traffic). In some embodiments, other data, such as different events including vehicle retrieval events, and so on, may be considered as the source of truth for AV crowd determination.

With respect to the second portion of the AV pullover clustering prevention approach, the pullover crowding mitigation component 130 may utilize the determined AV crowd definition (also referred to herein as an AV crowding metric) provided by pullover crowding tuner 120 to perform an AV crowding mitigation process that adjusts the AV's intended destination to diffuse any AV crowding at the location. In one embodiment, the pullover crowding mitigation component 130 can perform the AV crowding mitigation process when a ride is requested by a user (e.g., at an offer generation stage) and can be used to filter out pickup and drop-off locations based on the following inputs: (1) a set of candidate pullover locations around or near the requested location, and (2) a set of active pickup waypoints for the entire fleet of AVs that are expected to end in the area of the requested pullover location.

In embodiments herein, when a ride (i.e., a transportation trip request) is requested by a user, the user may indicate origin and destination locations for the ride. In some embodiments, the origin and destination locations are considered as requests, and the ride sharing platform determines the actual pickup and drop-off locations for the ride based on a variety of factors, including crowding prevention as discussed herein. A set of pickup locations and drop-off locations for the identified origin and destination locations are determined by the route coordination system 110. In one embodiment, the pickup locations and the drop-off locations are within a determined radius of the respective origin location and destination location and are identified as locations that the AV is capable of pulling over at in order for the AV to service the transportation trip request. The pullover crowding mitigation component 130 can apply the AV crowding mitigation process to the pickup and drop-off locations (also collectively referred to herein as pullover locations) to filter out any pullover locations that satisfy the AV crowding metric defined by pullover crowding tuner 120.

In one embodiment, the pullover crowding mitigation component 130 may implement a simplified algorithm that splits a time between ‘MIN_PULLOVER_TIME’ and ‘MAX_PULLOVER_TIME’ minutes into the future to 1 minute long buckets. The pullover crowding mitigation component 130 can denote the estimated time of arrival (ETA) for each waypoint (e.g., pullover location) as Tᵢ and compute from it the arrival window for each waypoint to be between Tᵢαₘᵢₙ and Tᵢαₘₐₓ. For each 1 minute time bucket, the pullover crowding mitigation component 130 can then compute how many AVs are expected to be at each of the waypoints (pullover locations). For each pullover location, the pullover crowding mitigation component 130 can then compute the number of windows where the number of AVs is above a certain threshold of probability that there is a crowd (“crowding threshold”; as defined by the AV crowding internal definition determined by pullover crowding tuner). In one embodiment, each 1 minute time bucket can have a probability associated with it and filtering can be applied based on whether the probability threshold is exceeded. If the number is above the crowding threshold, the pullover crowding mitigation component 130 can filter that pullover location from the displayed result.

In another embodiment, the pullover crowding mitigation component 130 may implement a probabilistic model that follows similar lines as the simplified algorithm, but uses a probability distribution of ETA error and arrival time computed from historical values. The probabilistic model then computes the probability of a crowding event for each pullover location and filters pullover locations where this probability is above a determined threshold.

In some embodiments, parameters of the different approaches (e.g., simplified, probabilistic) discussed above can be tuned offline based on recent data. For example, for each historical pickup waypoint of recent data, it can be simulated whether or not a pullover location would be filtered out based on recent pickup waypoints that are available in the fleet when the waypoint was created. Then, a change is determined in the number of crowding events due to the filtering against the percentage of overall waypoints that would be filtered using the proposed approach for different filtering thresholds. A quality of the approach can then be determined based on this comparison. For each algorithm we also computed the average increase to reachability for the affected waypoints and filtering precision (e.g., % of filtered waypoints that ended up being part of a crowding event). From these different options can be selected for implementation.

In implementations herein, pullover crowding mitigation component 130 may operate in tandem with route determination component 140 to provide pullover locations for pickup and drop-off for a route generated by route determination component 140. The route determination component 140 may utilize the output of pullover crowding mitigation component 130 to provide a list of pullover locations for a user to select from. Once the pullover locations are selected, the route determination component 140 may generate a route between the pullover locations for the AV to navigate. Route determination component 140 may provide the determined route, including the pullover location(s) determined to diffuse AV crowding, to AV dispatcher 150 to cause the AV to navigate the determined route.

In some embodiments, route determination component 140 may dynamically adjust a route in real-time responsive to the pullover crowding mitigation component 130 determining that the probability of an AV crowd at a drop-off location exceeds a determined threshold. In this case, the route determination component 140 may provide the user with one or more alternative pullover locations to select from, and/or may select a new drop-off location to route to (e.g., without user feedback) in order to diffuse the AV crowd.

In some implementations, other approaches may be implemented by the pullover crowding mitigation component 130 to prevent AV pullover crowding. In the above example, each AV may communicate with AV dispatcher 150 using, for example, a central dispatch API. In this case, the AV dispatcher 150 coordinates AV pullover crowding mitigation (based on the output of the pullover crowding mitigation component 130). However, in one example approach, the AVs could communicate with each other locally. For example, the AVs may communicate locally with each other to skip a pullover if another AV is detected within 50 meters.

In another implementation, a predetermined pullover location may be provided that only AVs are allowed to access. In this approach, “good” pullovers can be guaranteed for users, and the pullover crowding mitigation component 130 can continue to operate to determine when the space is occupied to prevent too many AVs from queueing. This can also be utilized to turn one customer's drop-off into another's pickup.

In some implementations, the pullover crowding mitigation component 130 can be used to detect pullover location crowding between AVs, which can then be used to trigger different behaviors to mitigate the crowding events. For example, if there are too many AVs enroute to destinations nearby one another, the pullover crowding mitigation component 130 can prevent another AV from heading to the same destination and can instead route them to a destination further away. Or, the AV can be set to drive in a “holding” pattern until the crowding event has cleared.

Implementations can also be expanded to prevent crowding outside of the use case of an AV crowding in a self-driving car service. For example, when an AV detects general traffic (i.e., not just AV crowding or clustering) at a pullover location, the AV dispatcher 150 (based on feedback from pullover crowding mitigation component 130) can automatically reroute the pullover location to a different location, informing the user that time can be saved due by rerouting the pullover location due to live traffic updates. In this case, the pullover location can be re-routed for AVs that are not already in (and therefore not detecting) the traffic. Similarly, the pullover crowding mitigation component 130 can detect and prevent AV crowding at high-traffic venues, such as theaters and arenas.

Furthermore, the AV pullover crowding mitigation can also apply to predetermined locations, such as airports. In the case of predetermined location, the pullover crowding mitigation component 130 may know how many AVs are queuing at a location's pickup area and can monitor real-time supply and demand to send more or fewer AVs to the location. These queues can be used in other venues as a fixed or temporary solution based on demand patterns. For example, the queues may be active at all times in some venues, such as airports, or may be intermittently created in other venues based on demand patterns.

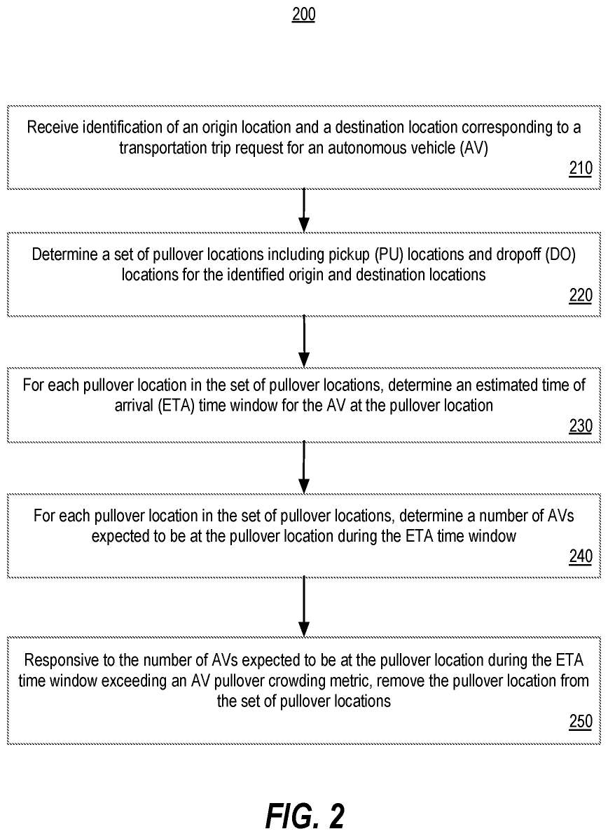

FIG. 2 illustrates an example method 200 implementing AV pullover clustering prevention, in accordance with embodiments herein. Although the example method 200 depicts a particular sequence of operations, the sequence may be altered without departing from the scope of the disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some embodiments, the method 200 includes block 210 where an identification is received of an origin location and a destination location corresponding to a transportation trip request for AV. Then, at block 220, a set of pullover locations is determined, where the set of pullover locations can include pickup locations and drop-off locations for the identified origin and destination locations.

Subsequently, at block 230, for each pullover location in the set of pullover locations, an ETA time window is determined for the AV at the pullover location. Then, at block 240, for each pullover location in the set of pullover locations, a number of AVs expected to be at the pullover location during the ETA time window is determined. Lastly, at block 250, responsive to the number of AVs expected to be at the pullover location during the ETA time window exceeding an AV pullover crowding metric, the pullover location is removed from the set of pullover locations.

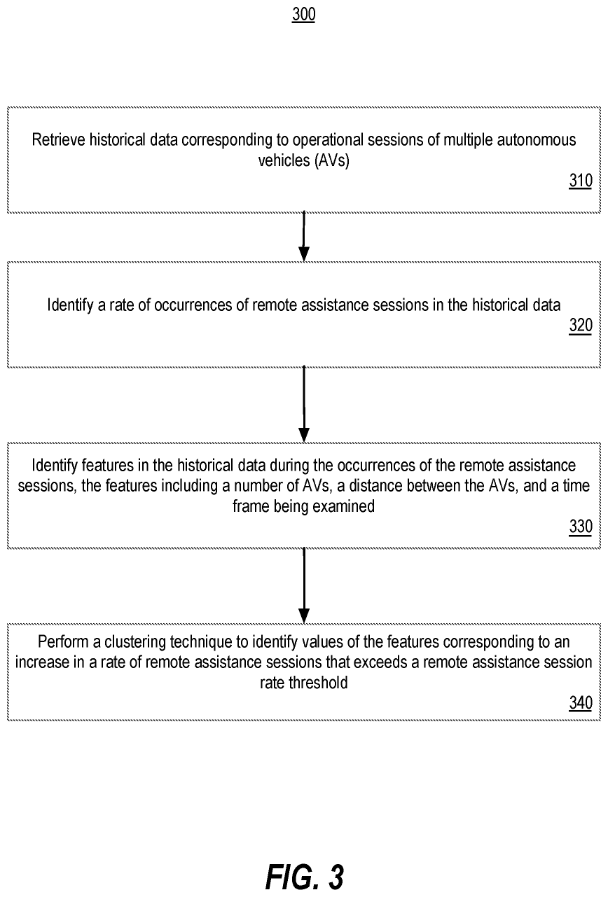

FIG. 3 illustrates an example method 300 for defining an AV pullover crowding metric for AV pullover clustering prevention, in accordance with embodiments herein. Although the example method 300 depicts a particular sequence of operations, the sequence may be altered without departing from the scope of the disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, the method 300 includes block 310 where historical data corresponding to operational sessions of multiple AVs is retrieved. Then, at block 320, a rate of occurrences of remote assistance sessions in the historical data is identified.

Subsequently, at block 330, features are identified in the historical data during the occurrences of the remote assistance sessions. In one embodiment, the features include a number of AVs, a distance between the AVs, and a time frame being examined. Lastly, at block 340, a clustering technique is performed to identify values of the features corresponding to an increase in a rate of remote assistance sessions that exceeds a remote assistance session rate threshold.

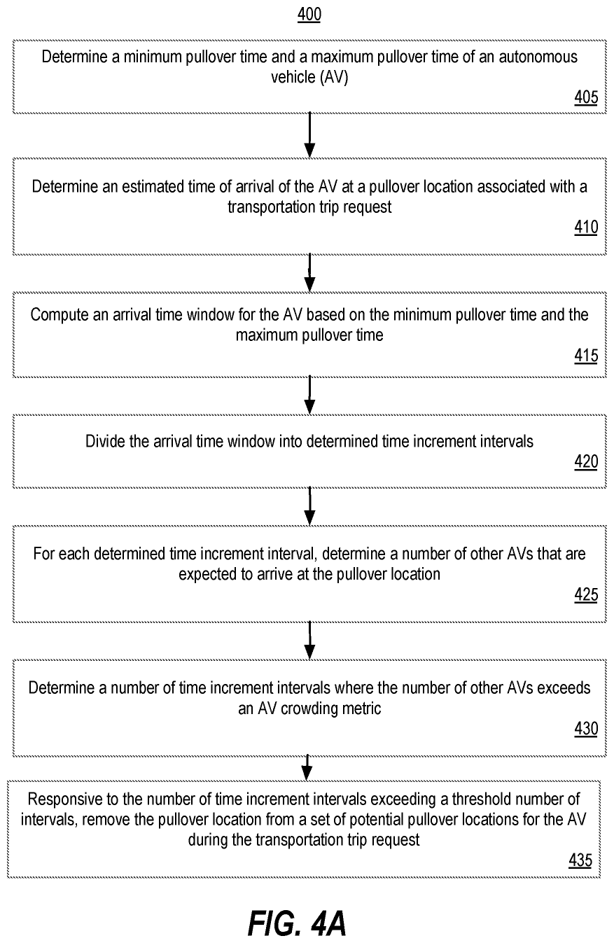

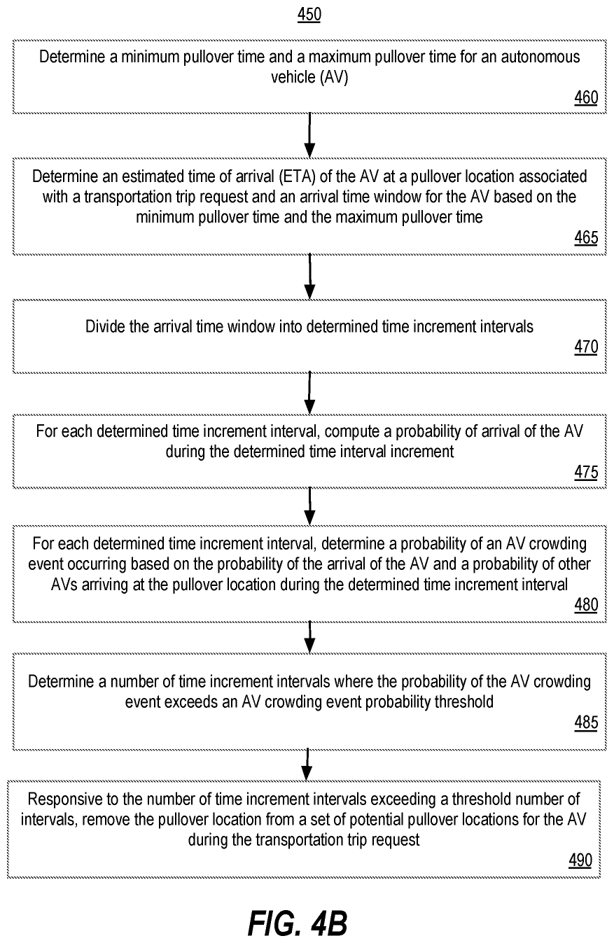

FIG. 4A illustrates an example method 400 for implementing an AV pullover clustering mitigation process, in accordance with embodiments herein. Although the example method 400 depicts a particular sequence of operations, the sequence may be altered without departing from the scope of the disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some embodiments, the method 400 includes block 405 where a minimum pullover time and a maximum pullover time for an AV is determined. Then, at block 410, an ETA of the AV at a pullover location associated with a transportation trip request is determined. Then, at block 415, an arrival time window for the AV is determined based on the minimum pullover time and the maximum pullover time.

Subsequently, at block 420, the arrival time window is divided into determined time increment intervals. Then, at block 425, for each determined time increment interval, a number of other AVs that are expected to arrive at the pullover location is determined. At block 430, a number of time increment intervals where the number of other AVs exceeds an AV crowding metric is determined. Lastly, at block 435, responsive to the number of time increment intervals exceeding a threshold number of intervals, the pullover location is removed from a set of potential pullover locations for the AV during the transportation trip request.

FIG. 4B illustrates an example method 450 for implementing an AV pullover clustering mitigation process using a probabilistic approach, in accordance with embodiments herein. Although the example method 450 depicts a particular sequence of operations, the sequence may be altered without departing from the scope of the disclosure. For example, some of the operations depicted may be performed in parallel or in a different sequence that does not materially affect the function of the method 450. In other examples, different components of an example device or system that implements the method 450 may perform functions at substantially the same time or in a specific sequence.

According to some embodiments, the method 450 includes block 460 where determine a minimum pullover time and a maximum pullover time for an AV. Then, at block 465, an ETA of the AV at a pullover location associated with a transportation trip request is determined, and an arrival time window for the AV based on the minimum pullover time and the maximum pullover time is also determined. At block 470, the arrival time window is divided into determined time increment intervals.

Subsequently, at block 475, for each determined time increment interval, a probability of arrival of the AV during the determined time interval increment is computed. Then, at block 480, for each determined time increment interval, a probability of an AV crowding event occurring is determined based on the probability of the arrival of the AV and a probability of other AVs arriving at the pullover location during the determined time increment interval.

At block 485, a number of time increment intervals where the probability of the AV crowding event exceeds an AV crowding event probability threshold is determined. Lastly, at block 490, responsive to the number of time increment intervals exceeding a threshold number of intervals, the pullover location is removed from a set of potential pullover locations for the AV during the transportation trip request.

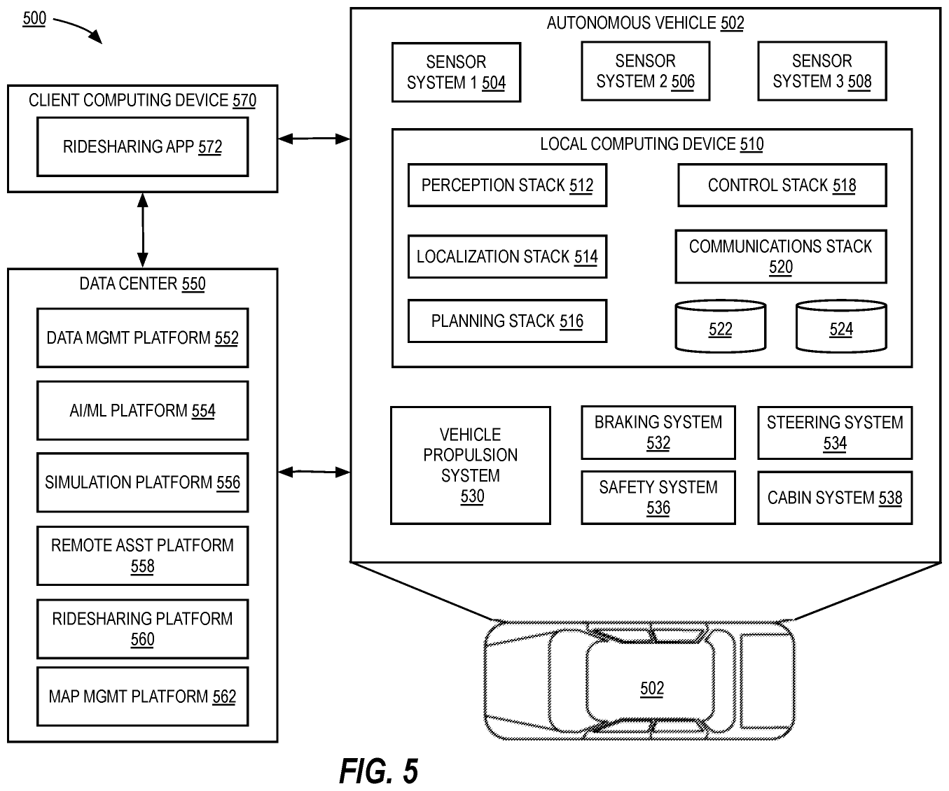

Turning now to FIG. 5, this figure illustrates an example of an AV management system 500. In one embodiment, the AV management system 500 can implement AV pullover clustering prevention, as described further herein. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate about roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

AV 502 can also include several mechanical systems that can be used to maneuver or operate AV 502. For instance, the mechanical systems can include vehicle propulsion system 530, braking system 532, steering system 534, safety system 536, and cabin system 538, among other systems. Vehicle propulsion system 530 can include an electric motor, an internal combustion engine, or both. The braking system 532 can include an engine brake, a wheel braking system (e.g., a disc braking system that utilizes brake pads), hydraulics, actuators, and/or any other suitable componentry configured to assist in decelerating AV 502. The steering system 534 can include suitable componentry configured to control the direction of movement of the AV 502 during navigation. Safety system 536 can include lights and signal indicators, a parking brake, airbags, and so forth. The cabin system 538 can include cabin temperature control systems, in-cabin entertainment systems, and so forth. In some embodiments, the AV 502 may not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a planning stack 516, a control stack 518, a communications stack 520, a High Definition (HD) geospatial database 522, and an AV operational database 524, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some embodiments, the AV 502 can compare sensor data captured in real-time by the sensor systems 504-508 to data in the HD geospatial database 522 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The planning stack 516 can determine how to maneuver or operate the AV 502 safely and efficiently in its environment. For example, the planning stack 516 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 502 from one point to another. The planning stack 516 can determine multiple sets of one or more mechanical operations that the AV 502 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 502 to go around the block instead of blocking a current lane while waiting for an opening to change lanes.

The control stack 518 can manage the operation of the vehicle propulsion system 530, the braking system 532, the steering system 534, the safety system 536, and the cabin system 538. The control stack 518 can receive sensor signals from the sensor systems 504-508 as well as communicate with other stacks or components of the local computing device 510 or a remote system (e.g., the data center 550) to effectuate operation of the AV 502. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit.

The communication stack 520 can transmit and receive signals between the various stacks and other components of the AV 502 and between the AV 502, the data center 550, the client computing device 570, and other remote systems. The communication stack 520 can enable the local computing device 510 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 522 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 524 can store raw AV data generated by the sensor systems 504-508 and other components of the AV 502 and/or data received by the AV 502 from remote systems (e.g., the data center 550, the client computing device 570, etc.). In some embodiments, the raw AV data can include HD LIDAR point cloud data, image or video data, RADAR data, GPS data, and other sensor data that the data center 550 can use for creating or updating AV geospatial data as discussed further below with respect to FIG. 5 and elsewhere in the present disclosure.

The data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and the client computing device 570. These signals can include sensor data captured by the sensor systems 504-508, roadside assistance requests, software updates, ridesharing pick-up and drop-off instructions, and so forth. In this example, the data center 550 includes one or more of a data management platform 552, an Artificial Intelligence/Machine Learning (AI/ML) platform 554, a simulation platform 556, a remote assistance platform 558, a ridesharing platform 560, and a map management platform 562, among other systems.

Data management platform 552 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from the map management platform 562; modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to be picked up or dropped off from the ridesharing application 572 and dispatch the AV 502 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

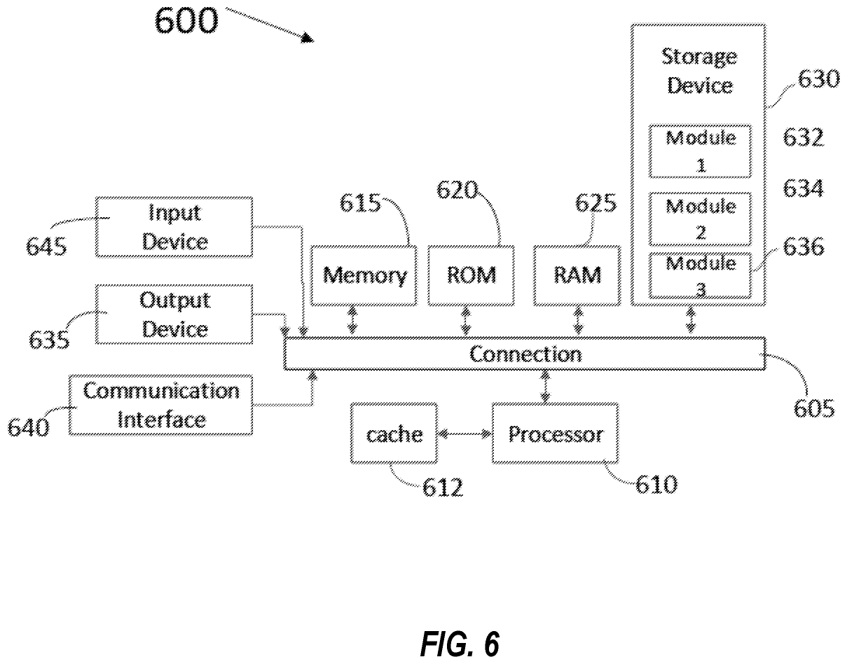

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the hardware components, such as processor 610, connection 605, output device 635, etc., to carry out the function.

Embodiments within the scope of the disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions utilized in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 includes a computer-implemented method for facilitating AV pullover clustering prevention, where the method comprises receiving, by a processing device, identification of an origin location and a destination location corresponding to a transportation trip request for an autonomous vehicle (AV); determining, by the processing device, a set of pullover locations comprising pickup locations for the origin location and drop-off locations for the destination location; for each pullover location of the set of pullover locations: determining, by the processing device, an estimated time of arrival (ETA) time window for the AV at the pullover location; determining a number of other AVs expected to be at the pullover location during the ETA time window; and responsive to the number of other AVs expected to be at the pullover location during the ETA time window exceeding an AV pullover crowding metric, removing the pullover location from the set of pullover locations to produce a revised set of pullover locations.

In Example 2, the subject matter of Example 1 can optionally include wherein the pickup locations and the drop-off locations are within a determined radius of the respective origin location and destination location and are identified as locations that an autonomous vehicle (AV) is capable of pulling over at for the AV to service the transportation trip request. In Example 3, the subject matter of any one of Examples 1-2 can optionally include further comprising: presenting the revised set of pullover locations to a user requesting the transportation trip request; receiving identification of a selected pickup location and a selected drop-off location selected by the user from the revised set of pullover locations; and generating a route for the AV between the selected pickup location and the selected drop-off location.

In Example 4, the subject matter of any one of Examples 1-3 can optionally include wherein the AV pullover crowding metric defines an AV cluster based on a number of AVs within a determined distance and within a determined time frame. In Example 5, the subject matter of any one of Examples 1-4 can optionally include wherein the AV pullover crowding metric is defined based on analyzing historical data to identify values of the number of AVs, distance, and time frame that result in an increase in a rate of remote assistance sessions above a determined threshold increase, and wherein the AV pullover crowding metric is defined using two-stage clustering to vary the values of the number of AVs, distance, and time frame with reference to the remote assistance sessions. In Example 6, the subject matter of any one of Examples 1-5 can optionally include further comprising estimating a presence of other actors at the pullover location during the ETA time window, wherein removing the pullover location from the set of pullover locations is further based on data corresponding to the presence of the other actors, and wherein the estimating the presence of the other actors is based at least on information provided by the other AVs.

In Example 7, the subject matter of any one of Examples 1-6 can optionally include further comprising: determining a probability distribution of error of the ETA time window based on historical data; computing a probability that the AV pullover crowding metric is to be exceeded during the ETA time window; and filtering the pullover locations from the set of pullover locations responsive to the probability exceeding a threshold probability. In Example 8, the subject matter of any one of Examples 1-7 can optionally include further comprising: dividing the ETA time window into time increments; for each pullover location of the set of pullover locations, determining a number of the time increments where the number of other AVs expected to be at the pullover location during each time increment of the ETA time window exceeding an AV pullover crowding metric; and response to the number of time increments exceeding a threshold time increment value, removing the pullover location from the set of pullover locations to produce a revised set of pullover locations.

In Example 9, the subject matter of any one of Examples 1-8 can optionally include further comprising responsive to a real-time traffic metric exceeding a traffic threshold value during the ETA time window, removing the pullover location from the set of pullover locations to produce a revised set of pullover locations.

Example 10 includes an apparatus for facilitating AV pullover clustering prevention, the apparatus of Example 10 comprising one or more hardware processors to: receive identification of an origin location and a destination location corresponding to a transportation trip request for an autonomous vehicle (AV); determine a set of pullover locations comprising pickup locations for the origin location and drop-off locations for the destination location; for each pullover location of the set of pullover locations: determine an estimated time of arrival (ETA) time window for the AV at the pullover location; determine a number of other AVs expected to be at the pullover location during the ETA time window; and responsive to the number of other AVs expected to be at the pullover location during the ETA time window exceeding an AV pullover crowding metric, remove the pullover location from the set of pullover locations to produce a revised set of pullover locations.

In Example 11, the subject matter of Example 10 can optionally include wherein the pickup locations and the drop-off locations are within a determined radius of the respective origin location and destination location and are identified as locations that an autonomous vehicle (AV) is capable of pulling over at for the AV to service the transportation trip request. In Example 12, the subject matter of Examples 10-11 can optionally include wherein the one or more hardware processors are further to: present the revised set of pullover locations to a user requesting the transportation trip request; receive identification of a selected pickup location and a selected drop-off location selected by the user from the revised set of pullover locations; and generate a route for the AV between the selected pickup location and the selected drop-off location.

In Example 13, the subject matter of Examples 10-12 can optionally include wherein the AV pullover crowding metric defines an AV cluster based on a number of AVs within a determined distance and within a determined time frame. In Example 14, the subject matter of Examples 10-13 can optionally include wherein the one or more hardware processors are further to: determine a probability distribution of error of the ETA time window based on historical data; compute a probability that the AV pullover crowding metric is to be exceeded during the ETA time window; and filter the pullover locations from the set of pullover locations responsive to the probability exceeding a threshold probability.

In Example 15, the subject matter of Examples 10-14 can optionally include wherein the one or more hardware processors are further to: divide the ETA time window into time increments; for each pullover location of the set of pullover locations, determine a number of the time increments where the number of other AVs expected to be at the pullover location during each time increment of the ETA time window exceeding an AV pullover crowding metric; and response to the number of time increments exceeding a threshold time increment value, remove the pullover location from the set of pullover locations to produce a revised set of pullover locations.

Example 16 is a non-transitory computer-readable storage medium for facilitating AV pullover clustering prevention. The non-transitory computer-readable storage medium of Example 16 having stored thereon executable computer program instructions that, when executed by one or more processors, cause the one or more processors to: receive identification of an origin location and a destination location corresponding to a transportation trip request for an autonomous vehicle (AV); determine a set of pullover locations comprising pickup locations for the origin location and drop-off locations for the destination location; for each pullover location of the set of pullover locations: determine an estimated time of arrival (ETA) time window for the AV at the pullover location; determine a number of other AVs expected to be at the pullover location during the ETA time window; and responsive to the number of other AVs expected to be at the pullover location during the ETA time window exceeding an AV pullover crowding metric, remove the pullover location from the set of pullover locations to produce a revised set of pullover locations.

In Example 17, the subject matter of Example 16 can optionally include wherein the pickup locations and the drop-off locations are within a determined radius of the respective origin location and destination location and are identified as locations that an autonomous vehicle (AV) is capable of pulling over at for the AV to service the transportation trip request. In Example 18, the subject matter of Examples 16-17 can optionally include wherein the one or more processors are further to: present the revised set of pullover locations to a user requesting the transportation trip request; receive identification of a selected pickup location and a selected drop-off location selected by the user from the revised set of pullover locations; and generate a route for the AV between the selected pickup location and the selected drop-off location.

In Example 19, the subject matter of Examples 16-18 can optionally include wherein the AV pullover crowding metric defines an AV cluster based on a number of AVs within a determined distance and within a determined time frame. In Example 20, the subject matter of Examples 16-19 can optionally include wherein the one or more processors are further to: determine a probability distribution of error of the ETA time window based on historical data; compute a probability that the AV pullover crowding metric is to be exceeded during the ETA time window; and filter the pullover locations from the set of pullover locations responsive to the probability exceeding a threshold probability.

Example 21 is a system for facilitating AV pullover clustering prevention. The system of Example 21 can optionally include a memory to store a block of data, and one or more hardware processors to: receive identification of an origin location and a destination location corresponding to a transportation trip request for an autonomous vehicle (AV); determine a set of pullover locations comprising pickup locations for the origin location and drop-off locations for the destination location; for each pullover location of the set of pullover locations: determine an estimated time of arrival (ETA) time window for the AV at the pullover location; determine a number of other AVs expected to be at the pullover location during the ETA time window; and responsive to the number of other AVs expected to be at the pullover location during the ETA time window exceeding an AV pullover crowding metric, remove the pullover location from the set of pullover locations to produce a revised set of pullover locations.

In Example 22, the subject matter of Example 21 can optionally include wherein the pickup locations and the drop-off locations are within a determined radius of the respective origin location and destination location and are identified as locations that an autonomous vehicle (AV) is capable of pulling over at for the AV to service the transportation trip request. In Example 23, the subject matter of Examples 21-22 can optionally include wherein the one or more hardware processors are further to: present the revised set of pullover locations to a user requesting the transportation trip request; receive identification of a selected pickup location and a selected drop-off location selected by the user from the revised set of pullover locations; and generate a route for the AV between the selected pickup location and the selected drop-off location.

In Example 24, the subject matter of Examples 21-23 can optionally include wherein the AV pullover crowding metric defines an AV cluster based on a number of AVs within a determined distance and within a determined time frame. In Example 25, the subject matter of Examples 21-24 can optionally include wherein the one or more hardware processors are further to: determine a probability distribution of error of the ETA time window based on historical data; compute a probability that the AV pullover crowding metric is to be exceeded during the ETA time window; and filter the pullover locations from the set of pullover locations responsive to the probability exceeding a threshold probability.

In Example 26, the subject matter of Examples 21-25 can optionally include wherein the one or more hardware processors are further to: divide the ETA time window into time increments; for each pullover location of the set of pullover locations, determine a number of the time increments where the number of other AVs expected to be at the pullover location during each time increment of the ETA time window exceeding an AV pullover crowding metric; and response to the number of time increments exceeding a threshold time increment value, remove the pullover location from the set of pullover locations to produce a revised set of pullover locations.

Example 27 includes an apparatus comprising means for performing the method of any of the Examples 1-9. Example 28 is at least one machine readable medium comprising a plurality of instructions that in response to being executed on a computing device, cause the computing device to carry out a method according to any one of Examples 1-9. Example 29 is an apparatus for facilitating rig AV pullover clustering prevention, configured to perform the method of any one of Examples 1-9. Specifics in the Examples may be used anywhere in one or more embodiments.

The various embodiments described above are provided by way of illustration and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method comprising:
receiving, by a processing device, identification of an origin location and a destination location corresponding to a transportation trip request for an autonomous vehicle (AV);
determining, by the processing device, a set of pullover locations comprising pickup locations for the origin location and drop-off locations for the destination location;
for each pullover location of the set of pullover locations:
determining, by the processing device, an estimated time of arrival (ETA) time window for the AV at the pullover location;
determining a number of other AVs expected to be at the pullover location during the ETA time window; and
responsive to the number of other AVs expected to be at the pullover location during the ETA time window exceeding an AV pullover crowding metric, removing the pullover location from the set of pullover locations to produce a revised set of pullover locations.

2. The computer-implemented method of claim 1, wherein the pickup locations and the drop-off locations are within a determined radius of the respective origin location and destination location and are identified as locations that an autonomous vehicle (AV) is capable of pulling over at for the AV to service the transportation trip request.

3. The computer-implemented method of claim 1, further comprising:
presenting the revised set of pullover locations to a user requesting the transportation trip request;
receiving identification of a selected pickup location and a selected drop-off location selected by the user from the revised set of pullover locations; and
generating a route for the AV between the selected pickup location and the selected drop-off location.

4. The computer-implemented method of claim 1, wherein the AV pullover crowding metric defines an AV cluster based on a number of AVs within a determined distance and within a determined time frame.

5. The computer-implemented method of claim 4, wherein the AV pullover crowding metric is defined based on analyzing historical data to identify values of the number of AVs, distance, and time frame that result in an increase in a rate of remote assistance sessions above a determined threshold increase, and wherein the AV pullover crowding metric is defined using two-stage clustering to vary the values of the number of AVs, distance, and time frame with reference to the remote assistance sessions.

6. The computer-implemented method of claim 1, further comprising estimating a presence of other actors at the pullover location during the ETA time window, wherein removing the pullover location from the set of pullover locations is further based on data corresponding to the presence of the other actors, and wherein the estimating the presence of the other actors is based at least on information provided by the other AVs.

7. The computer-implemented method of claim 1, further comprising:
determining a probability distribution of error of the ETA time window based on historical data;
computing a probability that the AV pullover crowding metric is to be exceeded during the ETA time window; and
filtering the pullover locations from the set of pullover locations responsive to the probability exceeding a threshold probability.

8. The computer-implemented method of claim 1, further comprising:
dividing the ETA time window into time increments;
for each pullover location of the set of pullover locations, determining a number of the time increments where the number of other AVs expected to be at the pullover location during each time increment of the ETA time window exceeding an AV pullover crowding metric; and
response to the number of time increments exceeding a threshold time increment value, removing the pullover location from the set of pullover locations to produce a revised set of pullover locations.

9. The computer-implemented method of claim 1, further comprising responsive to a real-time traffic metric exceeding a traffic threshold value during the ETA time window, removing the pullover location from the set of pullover locations to produce a revised set of pullover locations.

10. An apparatus comprising:
one or more hardware processors to:
receive identification of an origin location and a destination location corresponding to a transportation trip request for an autonomous vehicle (AV);
determine a set of pullover locations comprising pickup locations for the origin location and drop-off locations for the destination location;
for each pullover location of the set of pullover locations:
determine an estimated time of arrival (ETA) time window for the AV at the pullover location;
determine a number of other A Vs expected to be at the pullover location during the ETA time window; and
responsive to the number of other AVs expected to be at the pullover location during the ETA time window exceeding an AV pullover crowding metric, remove the pullover location from the set of pullover locations to produce a revised set of pullover locations.

11. The apparatus of claim 10, wherein the pickup locations and the drop-off locations are within a determined radius of the respective origin location and destination location and are identified as locations that an autonomous vehicle (AV) is capable of pulling over at for the AV to service the transportation trip request.

12. The apparatus of claim 10, wherein the one or more hardware processors are further to:
present the revised set of pullover locations to a user requesting the transportation trip request;
receive identification of a selected pickup location and a selected drop-off location selected by the user from the revised set of pullover locations; and
generate a route for the AV between the selected pickup location and the selected drop-off location.

13. The apparatus of claim 10, wherein the AV pullover crowding metric defines an AV cluster based on a number of AVs within a determined distance and within a determined time frame.

14. The apparatus of claim 10, wherein the one or more hardware processors are further to:
determine a probability distribution of error of the ETA time window based on historical data;
compute a probability that the AV pullover crowding metric is to be exceeded during the ETA time window; and
filter the pullover locations from the set of pullover locations responsive to the probability exceeding a threshold probability.

15. The apparatus of claim 10, wherein the one or more hardware processors are further to:
divide the ETA time window into time increments;
for each pullover location of the set of pullover locations, determine a number of the time increments where the number of other AVs expected to be at the pullover location during each time increment of the ETA time window exceeding an AV pullover crowding metric; and
response to the number of time increments exceeding a threshold time increment value, remove the pullover location from the set of pullover locations to produce a revised set of pullover locations.

16. A non-transitory computer-readable medium having stored thereon instructions that, when executed by one or more processors, cause the one or more processors to:
receive identification of an origin location and a destination location corresponding to a transportation trip request for an autonomous vehicle (AV);
determine a set of pullover locations comprising pickup locations for the origin location and drop-off locations for the destination location;
for each pullover location of the set of pullover locations:
determine an estimated time of arrival (ETA) time window for the AV at the pullover location;
determine a number of other AVs expected to be at the pullover location during the ETA time window; and
responsive to the number of other AVs expected to be at the pullover location during the ETA time window exceeding an AV pullover crowding metric, remove the pullover location from the set of pullover locations to produce a revised set of pullover locations.

17. The non-transitory computer-readable medium of claim 16, wherein the pickup locations and the drop-off locations are within a determined radius of the respective origin location and destination location and are identified as locations that an autonomous vehicle (AV) is capable of pulling over at for the AV to service the transportation trip request.

18. The non-transitory computer-readable medium of claim 16, wherein the one or more processors are further to:
present the revised set of pullover locations to a user requesting the transportation trip request;
receive identification of a selected pickup location and a selected drop-off location selected by the user from the revised set of pullover locations; and
generate a route for the AV between the selected pickup location and the selected drop-off location.

19. The non-transitory computer-readable medium of claim 16, wherein the AV pullover crowding metric defines an AV cluster based on a number of AVs within a determined distance and within a determined time frame.

20. The non-transitory computer-readable medium of claim 16, wherein the one or more processors are further to:
determine a probability distribution of error of the ETA time window based on historical data;
compute a probability that the AV pullover crowding metric is to be exceeded during the ETA time window; and
filter the pullover locations from the set of pullover locations responsive to the probability exceeding a threshold probability.
